(19) United States
(12) Patent Application Publication
(10) Pub. No.: US 2026/0178186 A1
(43) Pub. Date: Jun. 25, 2026

(54) METHOD FOR DISPLAYING BOOK INFORMATION, COMPUTER DEVICE AND STORAGE MEDIUM

(71) Applicant: Beijing Zitiao Network Technology Co., Ltd., Beijing (CN)

(72) Inventors: Chuanqi JING, Beijing (CN); Jinghua LI, Beijing (CN); Zhuqing QU, Beijing (CN)

(21) Appl. No.: 18/837,042

(22) PCT Filed: Mar. 5, 2024
(86) PCT No.: PCT/CN2024/080038

§ 371 Date: Aug. 8, 2024

(30) Foreign Application Priority Data
Mar. 10, 2023 (CN) 202310231266.6

(51) Int. Cl. G06F 3/04883; G06F 3/01; G06F 3/0482

(52) U.S. Cl. CPC G06F 3/04883; G06F 3/017; G06F 3/0482

(57) ABSTRACT

The present disclosure provides a method for displaying book information, a computer device, and a storage medium, and the method includes: displaying book excerpt information corresponding to a plurality of target books on a book list page; the book excerpt information is determined based on book content of the target books; in response to a triggering operation to any of the book excerpt information, switching to display a target display page; the target display page is a book reading page or a book excerpt display page, the book reading page is used to display the book content of a first target book of the target books to which the book excerpt information instructed by the triggering operation belongs, and the book excerpt display page is used to display the book excerpt information respectively corresponding to a plurality of books including the target books.

The present application claims the priority and benefits of Chinese Patent Application No. 202310231266.6, filed on Mar. 10, 2023, which is incorporated herein by reference in its entirety as part of the present application.

### TECHNICAL FIELD

The present disclosure relates to a method for displaying book information, an apparatus, a computer device, and a storage medium.

### BACKGROUND

In book reading platforms, in order to recommend books to users, introduction information of books may be selected for displaying. For example, titles, authors, covers, and the like of the books may be displayed in the form of a list. However, the information presented by this information is not rich enough, and it is difficult for the users to select books of interest from the books listed.

### SUMMARY

Embodiments of the present disclosure at least provide a method for displaying book information and an apparatus, a computer device, and a storage medium.

In a first aspect, embodiments of the present disclosure provide a method for displaying book information, and the method includes: displaying book excerpt information corresponding to a plurality of target books on a book list page, in which the book excerpt information is determined based on book content of the target books; and in response to a triggering operation to any of the book excerpt information, switching to display a target display page, in which the target display page is a book reading page or a book excerpt display page, the book reading page is used to display the book content of a target book to which the book excerpt information instructed by the triggering operation belongs, and the book excerpt display page is used to display the book excerpt information respectively corresponding to a plurality of books including the target books.

In an optional embodiment, the book excerpt information of the target books is obtained by: determining pieces of candidate book excerpt information corresponding to the target books, in which the candidate book excerpt information is information selected by a user from the book content of the target books; and determining the book excerpt information of the target books from the pieces of candidate book excerpt information, based on attribute information corresponding to each of candidate book excerpt information in a plurality of attribute dimensions, respectively.

In an optional embodiment, a state attribute corresponding to the target books meets a preset condition, and the state attribute includes an update attribute of a chapter of a book and/or an interactive attribute of the book excerpt information of the book.

In an optional embodiment, the method further includes: in response to a collection operation for the book excerpt information, associating and storing the book excerpt information in collection information of a target book, in which the collection information of the target book is associated and stored with the book excerpt information instructed by the collection operation and also with selected information in the book content of the target book; and displaying at least a book to which pieces of book excerpt information of the collection information belongs as well as a quantity of the book excerpt information associated for each book on a book excerpt collection page.

In an optional embodiment, in response to the target display page being the book reading page, displaying the target display page, includes: in the book content of the target book to which the book excerpt information belongs, determining a display position at which the book excerpt information is located, and displaying the book content on the target display page based at the display position; and in response to a read triggering operation to the target books, determining a display position of a chapter in the book content, and updating and displaying the book content on the target display page based at the display position of the chapter, based on the chapter of a target book instructed by the read triggering operation.

In an optional embodiment, before displaying the target display page, the method further includes: displaying a book catalogue of the target book to which the book excerpt information belongs, in which the book catalogue includes chapter titles corresponding to a plurality of chapters of the target book, respectively; and in response to associated book excerpt information being present under a chapter corresponding to a chapter title, displaying the book excerpt information at an associated position of the chapter title that is displayed.

In an optional embodiment, displaying the book excerpt information corresponding to the plurality of target books on the book list page, includes: displaying book excerpt information corresponding to a firstly list target book in the plurality of the target books on the book list page, and associating and displaying book information for introducing the target books; and in response to a switching display operation for the target books, displaying book excerpt information and book information corresponding to other target books sequentially based on a display sequence corresponding to the plurality of the target books, and in response to the switching display operation instructing to switch a lastly list target book in the plurality of the target books, switching from the book list page to the book excerpt display page.

In a second aspect, embodiments of the present disclosure further provide an apparatus for displaying book information, and the apparatus includes: a first display module and a second display module. The first display module is configured to display book excerpt information corresponding to a plurality of target books on a book list page, in which the book excerpt information is determined based on book content of the target books; and the second display module is configured to, in response to a triggering operation to any of the book excerpt information, switch to display a target display page, in which the target display page is a book reading page or a book excerpt display page, the book reading page is used to display the book content of a target book to which the book excerpt information instructed by the triggering operation belongs, and the book excerpt display page is used to display the book excerpt information respectively corresponding to a plurality of books including the target books.

In an optional embodiment, the book excerpt information of the target books is obtained by: determining pieces of candidate book excerpt information corresponding to the target books, in which the candidate book excerpt information is information selected by a user from the book content of the target books; and determining the book excerpt information of the target books from the pieces of candidate book excerpt information, based on attribute information corresponding to each of candidate book excerpt information in a plurality of attribute dimensions, respectively.

In an optional embodiment, a state attribute corresponding to the target books meets a preset condition, and the state attribute includes an update attribute of a chapter of a book and/or an interactive attribute of the book excerpt information of the book.

In an optional embodiment, the apparatus further includes: a processing module, the processing module is configured to, in response to a collection operation for the book excerpt information, associate and store the book excerpt information in collection information of a target book, in which the collection information of the target book is associated and stored with the book excerpt information instructed by the collection operation and also with selected information in the book content of the target book; and display at least a book to which pieces of book excerpt information of the collection information belongs as well as a quantity of the book excerpt information associated for each book on a book excerpt collection page.

In an optional embodiment, in response to the target display page being the book reading page, displaying the target display page, the second display module is configured to, in the book content of the target book to which the book excerpt information belongs, determine a display position at which the book excerpt information is located, and display the book content on the target display page based at the display position; and in response to a read triggering operation to the target books, determine a display position of a chapter in the book content, and update and display the book content on the target display page based at the display position of the chapter, based on the chapter of a target book instructed by the read triggering operation.

In an optional embodiment, before displaying the target display page, the second display module is configured to display a book catalogue of the target book to which the book excerpt information belongs, in which the book catalogue includes chapter titles corresponding to a plurality of chapters of the target book, respectively; and in response to associated book excerpt information being present under a chapter corresponding to a chapter title, display the book excerpt information at an associated position of the chapter title that is displayed.

In an optional embodiment, displaying the book excerpt information corresponding to the plurality of target books on the book list page, the first display module is configured to display book excerpt information corresponding to a firstly list target book in the plurality of the target books on the book list page, and associate and display book information for introducing the target books; and in response to a switching display operation for the target books, display book excerpt information and book information corresponding to other target books sequentially based on a display sequence corresponding to the plurality of the target books, and in response to the switching display operation instructing to switch a lastly list target book in the plurality of the target books, switch from the book list page to the book excerpt display page.

In a third aspect, an optional realization of the present disclosure further provides a computer device, and the computer device includes a processor and a memory, in which the memory stores a machine readable instruction that can be executed by the processor, the processor is configured to execute the machine readable instruction stored in the memory, and when the machine readable instruction is executed by the processor, the processor executes steps in the above first aspect or any possible implementation of the first aspect.

In a fourth aspect, an optional realization of the present disclosure further provides a computer-readable storage medium, in which a computer program is stored in the computer-readable storage medium, and when the computer program is run by a computer device, the computer device executes steps in the above first aspect or any possible implementation of the first aspect.

In order to make the above purposes and features of the present disclosure more apparent and understandable, optional embodiments are specifically listed below, and it is described in detail below in combination with accompanying drawings.

### BRIEF DESCRIPTION OF DRAWINGS

In order to describe technical schemes of embodiments of the present disclosure more clearly, drawings required in the embodiments are briefly introduced below. The drawings here are incorporated into the description and constitute a part of the description, these drawings show the embodiments that comply with the present disclosure and are used together with the description to describe the technical schemes of the present disclosure. It should be understood that the following drawings only show some of the embodiments of the present disclosure, and therefore it should not be regarded as limiting the scope. For those of ordinary skill in the art, other relevant drawings may also be obtained according to these drawings without paying creative labor.

FIG. 1 shows a flow diagram of a method for displaying book information provided in an embodiment of the present disclosure;

FIG. 2 shows a schematic diagram of a book list page provided in an embodiment of the present disclosure;

FIG. 3 shows a schematic diagram of another book list page provided in an embodiment of the present disclosure;

FIG. 4 shows a schematic diagram of a book excerpt display page provided in an embodiment of the present disclosure;

FIG. 5 shows a schematic diagram of a book catalogue for displaying a target book provided in an embodiment of the present disclosure;

FIG. 6 shows a schematic diagram of a book excerpt collection page provided in an embodiment of the present disclosure;

FIG. 7 shows a schematic diagram of an apparatus for displaying book information provided in an embodiment of the present disclosure; and

FIG. 8 shows a schematic diagram of a computer device provided in an embodiment of the present disclosure.

### DETAILED DESCRIPTION

In order to make purposes, technical schemes, and advantages of embodiments of the present disclosure clearer, the technical schemes in the embodiments of the present disclosure are clearly and completely described below in combination with drawings in the embodiments of the present disclosure. Apparently, the embodiments described are only a part of the embodiments of the present disclosure, not all of the embodiments. Components of the embodiments of the present disclosure typically described and shown here may be arranged and designed in various different configurations. Therefore, the following detailed description of the embodiments of the present disclosure is not intended to limit the scope of protection claimed by the present disclosure, but only to represent the selected embodiments of the present disclosure. Based on the embodiments of the present disclosure, all other embodiments obtained by those skilled in the art without creative labor shall fall within the scope of protection of the present disclosure.

It is found from researches that in book reading platforms, books are recommended to users by displaying information such as titles, covers, and authors of the books. However, this information is limited, it is difficult for the users to understand content contained in these books according to this information displayed, and it is also difficult for the users to select books of interest therefrom for reading.

Based on the above researches, the present disclosure provides a method for displaying book information. When the books are recommended to the users, a mode is specifically selected to display book excerpt information corresponding to a target book recommended, thus the information displayed is richer. Since the users generally have consumption habits of fragmented reading, it is easy for the users to read concise and clear book excerpt information on a book list page, and the book excerpt information is specifically determined from the book content. Therefore, after the displayed book excerpt information corresponding to each target book is read by the users, it may also be easier for the users to select books of interest therefrom.

In addition, after the users select the book excerpt information interested, they may continue to read the target book to which the book excerpt information belongs on a book reading page, or continue to view the book excerpt information of more books on a book excerpt display page. This means that relevant information that may be further consumed may be provided according to the users'selections, as to fully meet the different consumption intentions of the users.

The shortcomings of the above schemes are all results obtained by the inventor after practices and careful researches. Therefore, the discovery process of the above problems and solution schemes proposed in the present disclosure for the above problems in the following text should be contributions made by the inventor to the present disclosure in the disclosed process.

It should be noted that: similar labels and letters represent similar terms in the following drawings. Therefore, once a certain term is defined in one drawing, it does not need to be further defined and explained in the subsequent drawings.

For the convenience of understanding this embodiment, firstly a book excerpt information displaying method disclosed in an embodiment of the present disclosure is introduced in detail. The executive subject of the book excerpt information displaying method provided in the embodiment of the present disclosure is generally a computer device with certain computing power, and the computer device includes, for example, a terminal device, a server or other processing devices. The terminal device may be User Equipment (UE), a mobile device, a user terminal, a terminal, a cellular phone, a cordless phone, a Personal Digital Assistant (PDA), a handheld device, a computing device, a vehicle-mounted device, a wearable device and the like. In some possible implementation modes, the book excerpt information displaying method may be implemented by a mode that a processor calls a computer-readable instruction stored in a memory.

The book excerpt information displaying method provided in the embodiment of the present disclosure is described below. The book excerpt information displaying method provided in the embodiment of the present disclosure may be specifically applied to a book reading platform. In the book reading platform, it specifically includes pages that comprehensively display book information corresponding to books, such as a book list page, it may display book information of a plurality of books specifically. In order to enable the users to conveniently select books of interest on such comprehensive pages, in addition to displaying the book information, the embodiment of the present disclosure also displays the book excerpt information easily read by the users, so that the users may select the books for reading after reading the book excerpt information. In order to enable the users to intensively read a certain book, a book reading page is further provided on the book reading platform. In addition, when the users'reading intention tends to read the book excerpt information such as an exciting paragraph in each book, the book reading platform further provides a book excerpt display page, so that the users may intensively read the book excerpt information of a plurality of books, thereby the users'different reading needs are met.

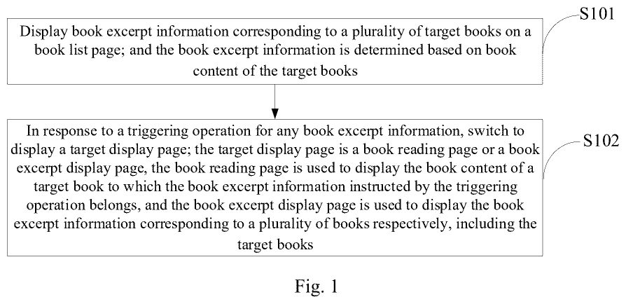

As shown in FIG. 1, it is a flow diagram of a method for displaying book information provided in an embodiment of the present disclosure, and the method includes steps S101˜S102.

S101: display book excerpt information corresponding to a plurality of target books on a book list page; and the book excerpt information is determined based on book content of the target books.

S102: in response to a triggering operation to any of the book excerpt information, switch to display a target display page; the target display page is a book reading page or a book excerpt display page, the book reading page is used to display the book content of a target book to which the book excerpt information instructed by the triggering operation belongs, and the book excerpt display page is used to display the book excerpt information respectively corresponding to a plurality of books including the target books.

The above S101˜S102 are described in detail below.

For the above S101, firstly a book list page in known technologies is introduced. The book list page is specifically used to recommend a plurality of books, so when being displayed, it is usually displayed in the form of a list, for example, a plurality of recommended books under different categories such as novels and biographies is displayed. When the books are displayed, covers and titles of the books are usually displayed, and correspondingly, attribute information such as a reading quantity may be added, so that the users may select books of interest from the plurality of the displayed books by this information.

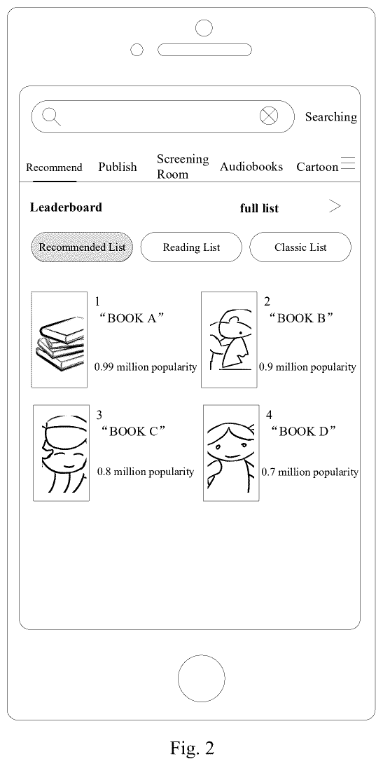

Exemplarily, as shown in FIG. 2, it is a schematic diagram of a book list page provided in an embodiment of the present disclosure. In this schematic diagram, a plurality of books under a “recommended list” is specifically displayed, which specifically includes covers, titles, and reading popularity of each book.

For the book list page shown in FIG. 2, after the users view the book information of each book, since the book title may provide less text information and the content that pictures may reflect is also limited, it is difficult for the users to determine whether they are interested in the book from this information provided, and they may not select a certain book to read, or they may find that they are not interested in the book after a certain book is selected to read, thus the users need to spend a long time to find the book that they are interested in.

Therefore, in the embodiment of the present disclosure, the book excerpt information of the book is selected to be displayed on the book list page, as to enrich information that may be read and assist the users in selecting the books of interest. In specific implementation, a plurality of target books displaying the book excerpt information may be determined firstly, and then the corresponding book excerpt information is determined for the target books.

In a possible situation, for the plurality of the books that are displayed already in the form of the list on the book list page, since the displayed information is less, the corresponding book excerpt information may be displayed below to supplement the information. Therefore, in this situation, for example, the plurality of the books displayed in the form of the list may be used as the target books.

In another possible situation, the target books may also be determined according to a specific preset condition. Specifically, a book that continuously updates chapters currently and/or a book that has good interaction with the book excerpt information determined in the book may be selected as the target books. In other words, a state attribute of the selected target books meets the preset condition, and the state attribute specifically includes an update attribute of a chapter of a book and/or an interactive attribute of the book excerpt information of the book.

The update attribute of the chapter may be measured according to a number of the chapter updated and updating frequency in the most recent period. For example, a book that a chapter is updated for more than three times in a past week, or a book that more than three chapters are updated in the past week, may be considered as the book that continuously updates the chapters currently. The interactive attribute of the book excerpt information may be measured according to a number of collectors, a number of likes, and other numerical values. For example, when the number of the collectors rises to more than 100 or the number of the likes exceeds 200, the book may be selected as the target books.

The above only lists two possible situations for determining the target books, specifically in determining the target books, an appropriate selection strategy may also be selected according to an actual situation. For example, when there is a book with higher reading popularity recently or a more recommended book on the platform, it may also be selected as the target books accordingly.

After the target books is selected, the book excerpt information corresponding to the target books may be displayed.

In another embodiment of the present disclosure, an implementation mode for determining the book excerpt information corresponding to the target books is further provided specifically. Since the book excerpt information is information that enables the users to understand the information of the target books by brief text information, the selection may be determined based on the content of the target books. In this way, not only writing style of the target books may be reflected, but also content features of the target books may be represented.

In specific implementation, the following mode may be used to obtain the book excerpt information of the target books: determine pieces of candidate book excerpt information corresponding to the target books; the candidate book excerpt information is information selected by a user from the book content of the target books; and determine the book excerpt information of the target books from the pieces of candidate book excerpt information, based on attribute information corresponding to each of candidate book excerpt information in a plurality of attribute dimensions, respectively.

In order to simplify the process of obtaining the book excerpt information and avoid directly extracting the book excerpt information from an original text of the target books with a large pieces of text, the embodiment of the present disclosure uses information already selected by the user in the target books to determine the book excerpt information of the target books. On the one hand, the book excerpt information is determined from the selected information, and the reduction of content quantity during screening may obtain the book excerpt information more easily. On the other hand, the information selected by the user, such as information checked when the user underlines or comments the article content during reading the target books, is mostly high-quality, exciting, and more attractive information considered by the user. Therefore, such information is more suitable as a representative text of the target books for displaying.

In one target book, the user may select a plurality of information from the book content, because different users have different preferred styles and different interested sentences. When the book excerpt information is displayed, the preferred selection is to display concise and refined text information, so not all of the selected information is displayed.

Therefore, for this candidate book excerpt information selected by the user, the pieces of candidate book excerpt information may also be screened according to the attribute information corresponding to each of candidate book excerpt information respectively in the plurality of the attribute dimensions, to obtain the book excerpt information displayed by the user.

The attribute information may specifically include at least one of the following: a number of users selecting the book content corresponding to the candidate book excerpt information, discussion popularity of the candidate book excerpt information, and discussion popularity corresponding to a plot of the candidate book excerpt information in the target book.

It is respectively described below for the above attribute information. For the attribute information corresponding to the number of the users selecting the book content corresponding to the candidate book excerpt information, according to the above explanation, each user who reads the target book may select the book content in the target book, and the selected book content may be used as the candidate book excerpt information. Therefore, for the book content corresponding to the candidate book excerpt information, there may be more than one user who completes a selection operation for this part of the book content ever. For example, for a very classic sentence in the target book, most users may underline or discuss it after reading. For example, it is specifically calculated that when 100 users select a certain sentence, then after this sentence is used as the candidate book excerpt information, the corresponding attribute information may be determined to include that the number of users selecting the book content corresponding to the candidate book excerpt information is 100.

When there are a large number of the users determined for the candidate book excerpt information, it is indicated that there is a reason to believe that the candidate book excerpt information has stronger readability, high-quality content, and higher probability of attracting more users to read. Therefore, when the book excerpt information of the target books is determined from the candidate book excerpt information by the attribute dimension, the candidate book excerpt information with a larger number of the corresponding users may be selected as the book excerpt information of the target books.

For the discussion popularity of the candidate book excerpt information, in a possible situation, the discussion popularity of the candidate book excerpt information may be determined according to the number of discussion information and the number of discussants and the like under the candidate book excerpt information. For example, when the user reads the target book on the book reading page, the book content of which may be discussed, the number of discussion users is not limited, and the number of discussion information is also not limited. For example, for a certain book content used as the candidate book excerpt information, there are 100 pieces of the discussion information on the book reading page, and there are 80 users participating in discussion. After this quantity information is obtained, the discussion popularity may be determined, such as a plurality of thresholds and a corresponding relationship between the corresponding discussion popularity are set. For example, when the number of the discussion information exceeds 90 and the number of the users exceeds 50, the corresponding discussion popularity is high. It may be specifically set according to the actual situation, and it is not repeatedly described here.

In another possible situation, the discussion popularity of the alternative information may also be based on the discussion popularity of the candidate book excerpt information on the entire network. For example, when the candidate book excerpt information or its corresponding content is involved in recent popular searches, videos with higher propagation capacity and the like, it may also be considered that the discussion popularity of the candidate book excerpt information is relatively high.

The above two modes may be combined to determine the discussion popularity corresponding to the candidate book excerpt information, or one of which may be selected according to the actual situation. Due to the higher discussion popularity of the candidate book excerpt information, it may be considered that there are more users interested in it and more phrases easy to trigger thinking. Therefore, there is also a high probability that the user who does not read the target books may generate interest in reading the target books by reading the candidate book excerpt information. Therefore, when the discussion popularity corresponding to the candidate book excerpt information is relatively high, it is more suitable to select as the book excerpt information of the target books.

For the discussion popularity corresponding to the plot of the candidate book excerpt information in the target books, it is similar to the discussion popularity corresponding to the above candidate book excerpt information, when the discussion popularity is determined, it is changed from the popularity of the candidate book excerpt information itself to the popularity of determining the corresponding plot. When the popularity is determined, the popularity under the plot of the book content corresponding to the candidate book excerpt information or the book chapter may be used as the discussion popularity here. In addition, the corresponding popularity of multimedia resources such as film and television clips may also be used as the discussion popularity here, and it is not repeatedly described specifically here.

In this way, by the attribute information corresponding to the candidate book excerpt information in the plurality of the attribute dimensions, the book excerpt information of the target books may be determined from the pieces of candidate book excerpt information. In a possible situation, the attribute information in the plurality of the attribute dimensions may be integrated to determine the book excerpt information of the target books, such as corresponding weight coefficients may be determined for the different attribute dimensions, it may be specifically selected and determined according to the actual situation.

In addition, when the book excerpt information is selected, the number of words and the like may also be limited. In order to enable the user to effectively read the book excerpt information, the book excerpt information may be concise. Therefore, a limitation on the number of words may also be set, such as the number of words for the book excerpt information is set to 10-30 words. In this way, it is easier for the user to read, and intact displaying may also be performed in a setting display area.

In this way, the corresponding book excerpt information may be determined for each of the target books.

After the corresponding book excerpt information is determined for a plurality of selected target books, the book excerpt information corresponding to the plurality of the target books may be displayed on the book list page. In specific implementation, the following mode may be specifically used to display the book excerpt information corresponding to each of the target books: display book excerpt information corresponding to a firstly list target book in the plurality of the target books on the book list page, and associate and display book information for introducing the target books; and in response to a switching display operation for the target books, display book excerpt information and book information corresponding to other target books sequentially based on a display sequence corresponding to the plurality of the target books, and in response to the switching display operation instructing to switch a lastly list target book in the plurality of the target books, switch from the book list page to the book excerpt display page.

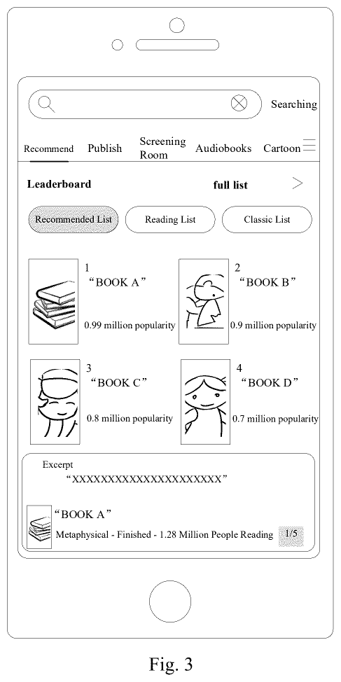

Exemplarily, as shown in FIG. 3, it is a schematic diagram of another book list page provided in an embodiment of the present disclosure. Since a certain space is required to display text when the book excerpt information is displayed, it may not be possible to display the book excerpt information corresponding to all selected target books on one page simultaneously. In the embodiment of the present disclosure, the book excerpt information corresponding to each of the target books is selected to display on the book list page one by one.

While the book excerpt information is displayed, the book information introducing the target books may also be associated and displayed. In an example shown in FIG. 3, the book information specifically includes covers, titles, book classification, book updating state, or a number of users currently reading, and other book information related to books such as authors may also be displayed.

Generally, the quantity of the book excerpt information corresponding to the target books displayed on the book list page is limited, for example, only the book excerpt information corresponding to 5 target books is displayed. When it is switched to display the book excerpt information corresponding to other target books, it may specifically respond to the switching display operation of right sliding, downward sliding and the like, and the book excerpt information and book information corresponding to the other target books are displayed sequentially according to the display sequence corresponding to the target books. In a bottom right corner of a page shown in FIG. 3, a “1/5” identifier is used to prompt the user that the currently displayed book excerpt information is the first book in sorting, and the number “5” represents the total number of the target books. Here, when it is switched to display the book information corresponding to other target books, the number “1” is changed accordingly.

When the book excerpt information corresponding to the target book is displayed, it also involves sorting the displaying of the target books. Herein when sorting, the sorting may be based on the plurality of the attribute dimensions as described above, or the sorting may also be based on the number of words for the book excerpt information corresponding to each of the target books, and it is specifically determined according to the actual situation.

In this way, the displaying of the book excerpt information corresponding to the plurality of the target books on the book list page may be completed.

In response to the above S102, for the book excerpt information corresponding to the plurality of the target books displayed on the book list page, it may also be switched to display a target display page in response to the user's triggering operation to any of the book excerpt information. The target display page may be a book reading page used to display the book content of a target book to which the book excerpt information instructed by the triggering operation belongs, or a book excerpt display page used to display the book excerpt information corresponding to a plurality of books including the target books. For detailed descriptions of the two pages, please refer to the following text specifically.

In a possible situation, for the book excerpt information of the plurality of the target books displayed on the book list page, after it is switched to display the book excerpt information corresponding to the lastly list target book, when the switching display operation of the user is continuously received, it may be considered that the user still has a reading demand for more book excerpt information, and the displaying may be switched from the book list page to the book excerpt display page. Herein, the book excerpt display page is used to display the book excerpt information respectively corresponding to a plurality of books including the target books.

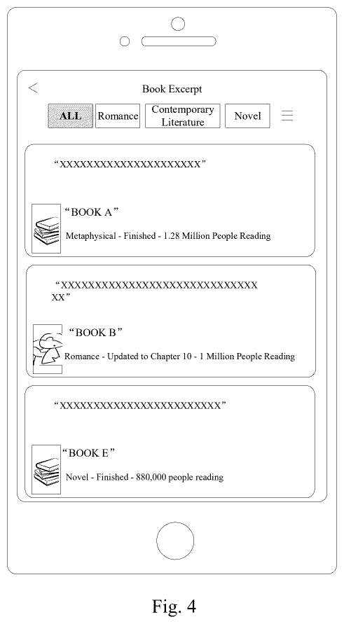

Exemplarily, as shown in FIG. 4, it is a schematic diagram of a book excerpt display page provided in an embodiment of the present disclosure. On the book excerpt display page, the book excerpt information corresponding to a plurality of books including the target book is displayed specifically. In addition, a plurality of book categories is also displayed specifically on the book excerpt display page, the user may select any book category from the plurality of the book categories according to own reading demand, and books and book excerpt information displayed below may also be switched accordingly. In this way, by the book excerpt display page, the user's reading demand for the book excerpt information corresponding to the different types of the books may also be met, and the user may spend a short time to read the high-quality book content from the plurality of the books.

In another embodiment of the present disclosure, for the book excerpt information of the plurality of the target books displayed on the book list page, when the user is interested in the target books corresponding to any of the book excerpt information after reading, it may also be switched to display the book reading page corresponding to the target book in response to the user's triggering operation.

In a possible situation, when the book reading of the selected target book is displayed to the user, it may be directly displayed from the first reading page of the target book. Alternatively, it may continue reading from the user's historical reading section according to the user's reading record of the target book.

In another possible situation, due to the user's operation for selecting the book excerpt information, it actually reflects the user's reading bias towards this book excerpt information in the target book. Therefore, before the book reading page is displayed to the user, a book catalogue of the target book to which the book excerpt information belongs may also be displayed; the book catalogue includes chapter titles corresponding to a plurality of chapters of the target book, respectively; and in response to associated book excerpt information being present under a chapter corresponding to a chapter title, the book excerpt information is displayed at an associated position of the chapter title displayed. In this way, the user may easily select a specific chapter to read by the displayed book catalogue associated with the book excerpt information.

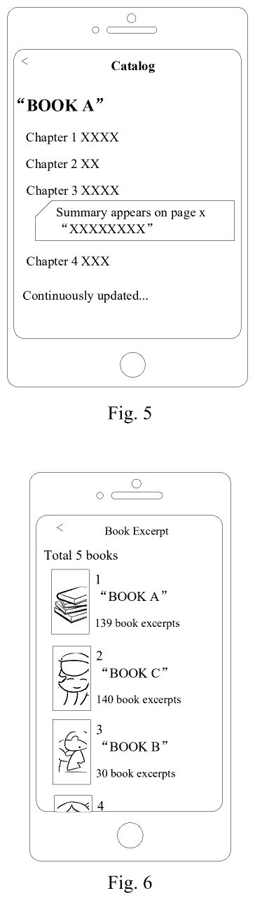

Exemplarily, as shown in FIG. 5, it is a schematic diagram of a book catalogue for displaying a target book provided in an embodiment of the present disclosure. In this example, the user specifically selects the book excerpt information corresponding to a “BOOK A”, and therefore the book catalogue corresponding to the “BOOK A” is displayed accordingly. In FIG. 5, titles corresponding to a plurality of chapters in the “BOOK A” are displayed specifically.

In a possible situation, the user may be interested in the book excerpt information and may have a need to directly read corresponding paragraphs, chapters and the like in the book. Therefore, while the chapter title corresponding to each chapter in the target book is displayed, the book excerpt information may also be displayed under the chapter associated with the book excerpt information. For example, as shown in FIG. 5, it is specifically associated with the book excerpt information under Chapter 3. Therefore, the book excerpt information is annotated and explained next to the display position of the title in the Chapter 3, and the specific number of pages which appear is also indicated.

When the user selects to view the target book, the book content of the target book may be displayed by the book reading page. In specific implementation, the following mode may be adopted: in the book content of the target book to which the book excerpt information belongs, determine a display position at which the book excerpt information is located, and display the book content on the target display page based at the display position; in response to a read triggering operation to the target books, determine a display position of a chapter in the book content; and update and display the book content on the target display page based at the display position of the chapter, based on the chapter of a target book instructed by the read triggering operation.

In this situation, since the user firstly expresses the interest in reading the book excerpt information, when the book content is displayed, the display position of the book excerpt information may be preferentially determined, and by this display position, a sentence containing the book excerpt information is firstly displayed to the user.

When the user has a reading demand for other positions or chapters, such as the triggering operation to selecting chapters or quickly flipping pages, namely the read triggering operation described in the embodiment of the present disclosure, may be performed. In response to receiving the read triggering operation, a chapter that the user instructs and wants to continue reading is determined according to the read triggering operation, and the display position of the chapter is determined similarly, and then the book content may be continuously displayed on the book reading page.

In another embodiment of the present disclosure, the user may also collect the book excerpt information displayed, to obtain a personal book excerpt favorite for easy viewing and browsing in the future. Such a book excerpt favorite may also serve as a mode to retain books of interest, in response to the user's selection and reading operation for any of the book excerpt information in the book excerpt favorite, it may also be switched to display the book reading page of the corresponding book. In this way, the user may easily judge which book it is interested in and select to continue reading by the book excerpt information collected in the book excerpt favorite.

In addition, for the book that the user already selects to read or adds to the reading, when the book excerpt information related to the book is viewed on the page containing the book list page, the book excerpt information may also be collected under the book, and together with the book excerpt information that the user already underlines and collects, it may be used as pieces of book excerpt information for the book.

In specific implementation, in response to a collection operation for the book excerpt information, associate and store the book excerpt information in collection information of a target book; the collection information of the target book is associated and stored with the book excerpt information instructed by the collection operation and also with selected information in the book content of the target book; display at least a book to which pieces of book excerpt information of the collection information belongs as well as a quantity of the book excerpt information associated for each book on a book excerpt collection page.

Exemplarily, as shown in FIG. 6, it is a schematic diagram of a book excerpt collection page provided in an embodiment of the present disclosure. For the book excerpt favorite described in the above embodiment, the content contained therein may be displayed on the book excerpt collection page. In order to enable the book excerpt information displayed to the user to be collected by the user in the book excerpt favorite, when the book excerpt information is displayed on any interface, a corresponding collection button may be displayed additionally. In a possible situation, in response to the user's triggering operation to the collection button corresponding to any of the book excerpt information, it is possible to firstly determine whether the book to which the book excerpt information belongs exists in the book excerpt favorite. When it exists, it is judged whether the book excerpt information is collected; and when the book excerpt information is already collected, a prompt message of “the book excerpt is already collected and may be viewed in the book excerpt favorite” may be displayed to the user, and when the book excerpt information is not collected yet, it may be associated and stored in the collection information of the target book, and a prompt message of “the book excerpt is successfully added to the book excerpt favorite already” may be displayed to the user.

In another possible situation, when it is determined that the book to which the book information belongs does not exist in the book excerpt favorite, it is necessary to add the information of the book to which the book excerpt information belongs to the book excerpt favorite, and associate and store the book excerpt information with the collection information of the book.

For the collection information of the book described above, it is specifically associated and stored with the book excerpt information instructed by the user for collection and storage, as well as the information selected and stored by the user itself during reading.

When the information is displayed on the book excerpt collection page, at least one book associated and stored with the book excerpt information may be displayed, and the quantity of the book excerpt information associated under each book may be displayed, as shown in FIG. 6. In addition, in response to the user's triggering operation to any book displayed on the page, the book excerpt information associated and stored under the book may also be displayed by a mode of page switching or pop-up window displaying.

In this way, it is also convenient for the user to manage and read the book excerpt information under each book.

It may be understood by those skilled in the art that in the above methods of the specific implementation modes, the writing order of each step does not imply a strict execution order and does not impose any limitations on the implementation process. The specific execution order of each step should be determined based on its functions and possible internal logics.

Based on the same inventive concept, the embodiment of the present disclosure further provides an apparatus for displaying book information corresponding to the method for displaying book information. Since the principle of the apparatus solving the problem in the embodiment of the present disclosure is similar to the method for displaying book information described in the embodiment of the present disclosure, the implementation of the apparatus may refer to the implementation of the method, and the repetition is not repeatedly described.

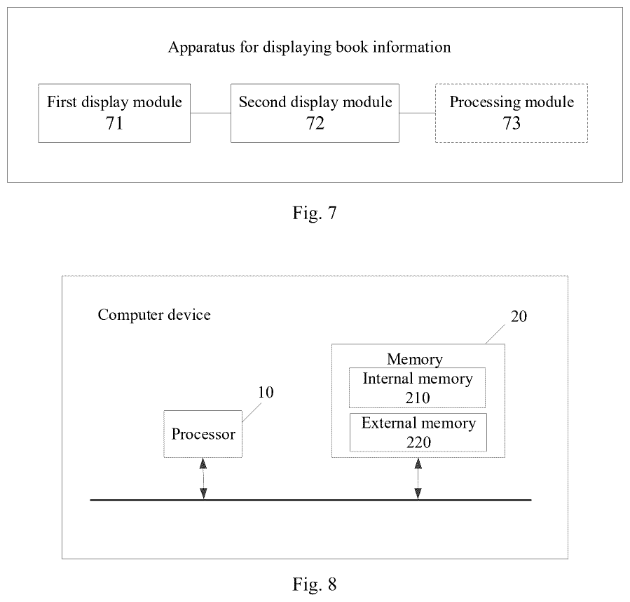

As shown in FIG. 7, it is a schematic diagram of an apparatus for displaying book information provided in an embodiment of the present disclosure, and the apparatus includes: a first display module 71 and a second display module 72.

The first display module 71 is configured to display book excerpt information corresponding to a plurality of target books on a book list page, in which the book excerpt information is determined based on book content of the target books.

The second display module 72 is configured to, in response to a triggering operation to any of the book excerpt information, switch to display a target display page, in which the target display page is a book reading page or a book excerpt display page, the book reading page is used to display the book content of a target book to which the book excerpt information instructed by the triggering operation belongs, and the book excerpt display page is used to display the book excerpt information respectively corresponding to a plurality of books including the target books.

In an optional embodiment, the book excerpt information of the target books is obtained by: determining pieces of candidate book excerpt information corresponding to the target books, in which the candidate book excerpt information is information selected by a user from the book content of the target books; and determining the book excerpt information of the target books from the pieces of candidate book excerpt information, based on attribute information corresponding to each of candidate book excerpt information in a plurality of attribute dimensions, respectively.

In an optional embodiment, a state attribute corresponding to the target books meets a preset condition, and the state attribute includes an update attribute of a chapter of a book and/or an interactive attribute of the book excerpt information of the book.

In an optional embodiment, the apparatus further includes: a processing module 73. The processing module 73 is configured to, in response to a collection operation for the book excerpt information, associate and store the book excerpt information in collection information of a target book, in which the collection information of the target book is associated and stored with the book excerpt information instructed by the collection operation and also with selected information in the book content of the target book; and display at least a book to which pieces of book excerpt information of the collection information belongs as well as a quantity of the book excerpt information associated for each book on a book excerpt collection page.

In an optional embodiment, in response to the target display page being the book reading page, displaying the target display page, the second display module 72 is configured to, in the book content of the target book to which the book excerpt information belongs, determine a display position at which the book excerpt information is located, and display the book content on the target display page based at the display position; and in response to a read triggering operation to the target books, determine a display position of a chapter in the book content, and update and display the book content on the target display page based at the display position of the chapter, based on the chapter of a target book instructed by the read triggering operation.

In an optional embodiment, before displaying the target display page, the second display module 72 is configured to display a book catalogue of the target book to which the book excerpt information belongs, in which the book catalogue includes chapter titles corresponding to a plurality of chapters of the target book, respectively; and in response to associated book excerpt information being present under a chapter corresponding to a chapter title, display the book excerpt information at an associated position of the chapter title that is displayed.

In an optional embodiment, displaying the book excerpt information corresponding to the plurality of target books on the book list page, the first display module 71 is configured to display book excerpt information corresponding to a firstly list target book in the plurality of the target books on the book list page, and associate and display book information for introducing the target books; and in response to a switching display operation for the target books, display book excerpt information and book information corresponding to other target books sequentially based on a display sequence corresponding to the plurality of the target books, and in response to the switching display operation instructing to switch a lastly list target book in the plurality of the target books, switch from the book list page to the book excerpt display page.

The description of the processing flow of each module in the apparatus and the interaction flow between each module may refer to the relevant descriptions in the above method embodiments, it is not elaborated here.

The embodiment of the present disclosure further provides a computer device, as shown in FIG. 8, it is a structure schematic diagram of the computer device provided in an embodiment of the present disclosure, and the computer device includes: a processor 10 and a memory 20.

The memory 20 stores a machine readable instruction that may be executed by the processor 10, the processor 10 is used to execute the machine readable instruction stored in the memory 20, and when the machine readable instruction is executed by the processor 10, the processor 10 executes the following steps:
display book excerpt information corresponding to a plurality of target books on a book list page; the book excerpt information is determined based on book content of the target books; in response to a triggering operation to any of the book excerpt information, switch to display a target display page; the target display page is a book reading page or a book excerpt display page, the book reading page is used to display the book content of a target book to which the book excerpt information instructed by the triggering operation belongs, and the book excerpt display page is used to display the book excerpt information respectively corresponding to a plurality of books including the target books.

The above memory 20 includes an internal memory 210 and an external memory 220; and the internal memory 210 here, also known as an internal storage, is used to temporarily store operational data in the processor 10 and data exchanged with the external memory 220 such as a hard disk, the processor 10 exchanges the data with the external memory 220 by the internal memory 210.

The specific execution process of the above instruction may refer to the steps of the method for displaying book information described in the embodiment of the present disclosure, and it is not repeatedly described here.

The embodiment of the present disclosure further provides a computer-readable storage medium, a computer program is stored in the computer-readable storage medium, and the steps of the method for displaying book information in the above method embodiment are executed when the computer program is executed by the processor. Herein, the storage medium may be a volatile or non-volatile computer-readable storage medium.

The embodiment of the present disclosure further provides a computer program product, the computer program product carries a program code, and the program code includes an instruction that may be used to execute the steps of the method for displaying book information described in the above method embodiment. It may refer to the above method embodiment for details, and it is not repeatedly described here.

The above computer program product may be specifically implemented by hardware, software, or a combination thereof. In an optional embodiment, the computer program product is specifically embodied as a computer storage medium, while in another optional embodiment, the computer program product is specifically embodied as a software product, such as a Software Development Kit (SDK).

It may be clearly understood by those skilled in the art that for the convenience and conciseness of the description, the specific working process of the system and the apparatus described above may refer to the corresponding process in the aforementioned method embodiment, it is not repeatedly described here. In the several embodiments provided in the present disclosure, it should be understood that the disclosed system, apparatus, and method may be implemented in other ways. The apparatus embodiments described above are only schematic. For example, the division of the units is only a logical function division, and there may be other division modes during actual implementation. For another example, a plurality of units or components may be combined or integrated into another system, or some features may be ignored or not executed. Another point is that coupling or direct coupling or communication connection between displayed or discussed may be indirect coupling or communication connection by some communication interfaces, apparatuses or units, which may be electrical, mechanical or other forms.

The units described as separate components may be or may not be physically separated, and the components displayed as the units may be or may not be physical units, namely it may be located in one place or distributed on a plurality of network units. Some or all units of which may be selected according to actual needs to achieve the purpose of the scheme in this embodiment.

In addition, various functional units in various embodiments of the present disclosure may be integrated into one processing unit, or each unit may physically exist separately, or two or more than two units may be integrated into one unit.

When the functions are implemented in the form of a software functional unit and sold or used as an independent product, it may be stored in a non-volatile computer-readable storage medium that may be executed by the processor. Based on this understanding, the technical scheme of the present disclosure, in other words the part that contributes to known technologies or the part of the technical scheme, may be essentially reflected in the form of a software product, the computer software product is stored in a storage medium and includes a plurality of instructions to enable a computer device (it may be a personal computer, a server, or a network device or the like) to perform all or part of the steps of the method in each embodiment of the present disclosure. The aforementioned storage medium includes: a universal serial bus (USB) flash drive, a portable hard drive, a Read-Only Memory (ROM), a Random Access Memory (RAM), a magnetic disk or an optical disk, and other media that may store a program code.

Finally, it should be noted that: the above embodiments are only specific implementation modes of the present disclosure, used to describe the technical schemes of the present disclosure, and not to limit it. The scope of protection of the present disclosure is not limited to this. Although the present disclosure is described in detail with reference to the aforementioned embodiments, those of ordinary skill in the art should understand that: any technical personnel familiar with this technical field may still modify or easily think of changes to the technical schemes recorded in the aforementioned embodiments within the scope of technologies disclosed in the present disclosure, or replace some of the technical features equivalently; and these modifications, changes, or replacements do not make the essence of the corresponding technical schemes deviate from the spirit and scope of the technical schemes in the embodiments of the present disclosure, and should be encompassed within the scope of protection of the present disclosure. Therefore, the scope of protection of the present disclosure shall be based on the scope of protection of the claims.

1. A method for displaying book information, comprising:
displaying book excerpt information corresponding to a plurality of target books on a book list page, wherein the book excerpt information is determined based on book content of the target books; and
in response to a triggering operation to any of the book excerpt information, switching to display a target display page, wherein the target display page is a book reading page or a book excerpt display page, the book reading page is used to display the book content of a first target book of the target books to which the book excerpt information instructed by the triggering operation belongs, and the book excerpt display page is used to display the book excerpt information respectively corresponding to a plurality of books comprising the target books.

2. The method according to claim 1, wherein the book excerpt information of the target books is obtained by:
determining pieces of candidate book excerpt information corresponding to the target books, wherein the candidate book excerpt information is information selected by a user from the book content of the target books; and
determining the book excerpt information of the target books from the pieces of candidate book excerpt information, based on attribute information corresponding to each of candidate book excerpt information in a plurality of attribute dimensions, respectively.

3. The method according to claim 1, wherein a state attribute corresponding to the target books meets a preset condition, and the state attribute comprises an update attribute of a chapter of a book and/or an interactive attribute of the book excerpt information of the book.

4. The method according to claim 1, further comprising:
in response to a collection operation for the book excerpt information, associating and storing the book excerpt information in collection information of a second target book of the target books, wherein the collection information of the second target book is associated and stored with the book excerpt information instructed by the collection operation and also with selected information in the book content of the second target book; and
displaying at least a book to which pieces of book excerpt information of the collection information belongs as well as a quantity of the book excerpt information associated for each book on a book excerpt collection page.

5. The method according to claim 1, wherein in response to the target display page being the book reading page, displaying the target display page, comprises:
in the book content of the first target book to which the book excerpt information belongs, determining a display position at which the book excerpt information is located, and displaying the book content on the target display page based at the display position; and
in response to a read triggering operation to the target books, determining a display position of a chapter in the book content, and updating and displaying the book content on the target display page based at the display position of the chapter, based on the chapter of a third target book of the target books instructed by the read triggering operation.

6. The method according to claim 1, wherein before displaying the target display page, the method further comprises:
displaying a book catalogue of the first target book to which the book excerpt information belongs, wherein the book catalogue comprises chapter titles corresponding to a plurality of chapters of the first target book, respectively; and
in response to associated book excerpt information being present under a chapter corresponding to a first chapter title of the chapter titles, displaying the book excerpt information at an associated position of the first chapter title that is displayed.

7. The method according to claim 1, wherein the displaying book excerpt information corresponding to a plurality of target books on a book list page, comprises:
displaying book excerpt information corresponding to a firstly list target book in the plurality of the target books on the book list page, and associating and displaying book information for introducing the target books; and
in response to a switching display operation for the target books, displaying book excerpt information and book information corresponding to other target books sequentially based on a display sequence corresponding to the plurality of the target books, and in response to the switching display operation instructing to switch a lastly list target book in the plurality of the target books, switching from the book list page to the book excerpt display page.

8. (canceled)

9. A computer device, comprising a processor and a memory, wherein the memory stores a machine readable instruction that can be executed by the processor, the processor is configured to execute the machine readable instruction stored in the memory, and when the machine readable instruction is executed by the processor, the processor executes steps of a method for displaying book information, and the method comprises:
displaying book excerpt information corresponding to a plurality of target books on a book list page, wherein the book excerpt information is determined based on book content of the target books; and
in response to a triggering operation to any of the book excerpt information, switching to display a target display page, wherein the target display page is a book reading page or a book excerpt display page, the book reading page is used to display the book content of a first target book of the target books to which the book excerpt information instructed by the triggering operation belongs, and the book excerpt display page is used to display the book excerpt information respectively corresponding to a plurality of books comprising the target books.

10. A non-transitory computer-readable storage medium, wherein a computer program is stored in the computer-readable storage medium, and when the computer program is run by a computer device, the computer device executes steps of a method for displaying book information, and the method comprises:
displaying book excerpt information corresponding to a plurality of target books on a book list page, wherein the book excerpt information is determined based on book content of the target books; and
in response to a triggering operation to any of the book excerpt information, switching to display a target display page, wherein the target display page is a book reading page or a book excerpt display page, the book reading page is used to display the book content of a first target book of the target books to which the book excerpt information instructed by the triggering operation belongs, and the book excerpt display page is used to display the book excerpt information respectively corresponding to a plurality of books comprising the target books.

11. The computer device according to claim 9, wherein the book excerpt information of the target books is obtained by:
determining pieces of candidate book excerpt information corresponding to the target books, wherein the candidate book excerpt information is information selected by a user from the book content of the target books; and
determining the book excerpt information of the target books from the pieces of candidate book excerpt information, based on attribute information corresponding to each of candidate book excerpt information in a plurality of attribute dimensions, respectively.

12. The computer device according to claim 9, wherein a state attribute corresponding to the target books meets a preset condition, and the state attribute comprises an update attribute of a chapter of a book and/or an interactive attribute of the book excerpt information of the book.

13. The computer device according to claim 9, wherein the method further comprises:
in response to a collection operation for the book excerpt information, associating and storing the book excerpt information in collection information of a second target book of the target books, wherein the collection information of the second target book is associated and stored with the book excerpt information instructed by the collection operation and also with selected information in the book content of the second target book; and
displaying at least a book to which pieces of book excerpt information of the collection information belongs as well as a quantity of the book excerpt information associated for each book on a book excerpt collection page.

14. The computer device according to claim 9, wherein in response to the target display page being the book reading page, displaying the target display page, comprises:
in the book content of the first target book to which the book excerpt information belongs, determining a display position at which the book excerpt information is located, and displaying the book content on the target display page based at the display position; and
in response to a read triggering operation to the target books, determining a display position of a chapter in the book content, and updating and displaying the book content on the target display page based at the display position of the chapter, based on the chapter of a third target book of the target books instructed by the read triggering operation.

15. The computer device according to claim 9, wherein before displaying the target display page, the method further comprises:
displaying a book catalogue of the first target book to which the book excerpt information belongs, wherein the book catalogue comprises chapter titles corresponding to a plurality of chapters of the first target book, respectively; and
in response to associated book excerpt information being present under a chapter corresponding to a first chapter title of the chapter titles, displaying the book excerpt information at an associated position of the first chapter title that is displayed.

16. The computer device according to claim 9, wherein the displaying book excerpt information corresponding to a plurality of target books on a book list page, comprises:
displaying book excerpt information corresponding to a firstly list target book in the plurality of the target books on the book list page, and associating and displaying book information for introducing the target books; and
in response to a switching display operation for the target books, displaying book excerpt information and book information corresponding to other target books sequentially based on a display sequence corresponding to the plurality of the target books, and in response to the switching display operation instructing to switch a lastly list target book in the plurality of the target books, switching from the book list page to the book excerpt display page.

17. The computer-readable storage medium according to claim 10, wherein the book excerpt information of the target books is obtained by:
determining pieces of candidate book excerpt information corresponding to the target books, wherein the candidate book excerpt information is information selected by a user from the book content of the target books; and
determining the book excerpt information of the target books from the pieces of candidate book excerpt information, based on attribute information corresponding to each of candidate book excerpt information in a plurality of attribute dimensions, respectively.

18. The computer-readable storage medium according to claim 10, wherein a state attribute corresponding to the target books meets a preset condition, and the state attribute comprises an update attribute of a chapter of a book and/or an interactive attribute of the book excerpt information of the book.

19. The computer-readable storage medium according to claim 10, wherein the method further comprises:
in response to a collection operation for the book excerpt information, associating and storing the book excerpt information in collection information of a second target book of the target books, wherein the collection information of the second target book is associated and stored with the book excerpt information instructed by the collection operation and also with selected information in the book content of the second target book; and
displaying at least a book to which pieces of book excerpt information of the collection information belongs as well as a quantity of the book excerpt information associated for each book on a book excerpt collection page.

20. The computer-readable storage medium according to claim 10, wherein in response to the target display page being the book reading page, displaying the target display page, comprises:
in the book content of the first target book to which the book excerpt information belongs, determining a display position at which the book excerpt information is located, and displaying the book content on the target display page based at the display position; and
in response to a read triggering operation to the target books, determining a display position of a chapter in the book content, and updating and displaying the book content on the target display page based at the display position of the chapter, based on the chapter of a third target book of the target books instructed by the read triggering operation.

21. The computer-readable storage medium according to claim 10, wherein before displaying the target display page, the method further comprises:
displaying a book catalogue of the first target book to which the book excerpt information belongs, wherein the book catalogue comprises chapter titles corresponding to a plurality of chapters of the first target book, respectively; and
in response to associated book excerpt information being present under a chapter corresponding to a first chapter title of the chapter titles, displaying the book excerpt information at an associated position of the first chapter title that is displayed.
